(19) United States
(12) Patent Application Publication
(10) Pub. No.: US 2005/0035153 A1
(43) Pub. Date: Feb. 17, 2005

(54) Multi-component fluid dispensing device with mixing enhancement

(76) Inventor: Daniel P. Brown, Palos Park, IL (US)

Correspondence Address: QUARLES & BRADY LLP, 411 E. WISCONSIN AVENUE, SUITE 2040, MILWAUKEE, WI, 53202-4497, US

(21) Appl. No.: 10/638,611

(22) Filed: Aug. 11, 2003

(51) Int. Cl. B67D 5/60

(52) U.S. Cl. 222/145.6

(57) ABSTRACT

A multi-component fluid mixing device having mixing enhancement within a mixing flow path for mixing at least two fluid components. At least one mixing screen is disposed in the mixing flow path to enhance mixing of the fluid components.

### CROSS REFERENCES TO RELATED APPLICATIONS

Not Applicable

### STATEMENT REGARDING FEDERALLY SPONSORED RESEARCH

Not Applicable

### TECHNICAL FIELD

This invention relates to a multi-component fluid mixing and dispensing device in which two or more fluid components are mixed and dispensed from the device as a settable fluid through a nozzle, and more particularly to a mixer and dispenser having a mixing enhancement for enhancing the mixing of the fluid components.

### DESCRIPTION OF THE BACKGROUND ART

Manually operable guns are known for dispensing a settable urethane foam. Separate fluid components are fed individually to the gun, passed separately through control valves, and brought into contact with each other upon reaching a mixing chamber of a nozzle from which the mixed components are discharged as foam. Examples of such guns are found in U.S. Pat. Nos. 4,311,254 and 4,399,930 issued to Gary Harding and in U.S. Pat. No. 4,762,253 issued to Steven Palmert.

The two fluid components are commonly referred to as the “A resin” and the “B resin”. They usually consist of polymeric isocyanate and polyol, respectively. In one particular dispensing device, the components are supplied separately and are attached by hoses to inlets on the guns. When the two fluid components or resins are mixed, the mixture quickly sets up to form a rigid foam product which is substantially insoluble and extremely difficult to remove from surfaces with which it comes in contact. As a result, the mixing nozzles for the guns in which the two components are first mixed are typically designed to be replaceable and disposable so as to avoid the necessity for cleaning the nozzles.

Foam quality is dependent upon the extent of the mixing of the fluid components. As a result, molded mixing nozzles incorporating a static mixer have been developed and are well known in the art. These static mixers typically include baffles or helical walls that elongate the flow path of the fluid components to provide more time for the fluid components to mix prior to being expelled from the nozzle. Other versions provide baffles which weave the liquids together as they travel the path of the mixing chamber. Still others work in a combination of impinging of the components upon each other.

These static mixers are generally adequate for mixing fluid components of a multi-component foam under ideal conditions. However, typical static mixers produce unacceptable results under adverse conditions, such as cold temperatures, low flow rates, and the like, and when mixing foam components having physical characteristics, such as high viscosity, low flowability, and the like. Of course, longer static mixers further increase the mixing flow path to provide additional time for mixing the fluid components can be provided. However, this solution increases the size of the nozzle and results in wasting foam. Accordingly, a need exists for an improved multi-component foam dispensing gun with mixing enhancement.

### SUMMARY OF THE INVENTION

The present invention provides a multi-component fluid dispensing device a defining a mixing flow path for mixing at least two fluid components. At least one mixing screen is disposed in the mixing flow path to enhance mixing of the fluid components.

A general objective of the present invention is to provide a multi-component fluid dispensing device having enhanced mixing. This objective is accomplished by inserting a mixing screen in the mixing flow path.

The foregoing and other objectives and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF SUMMARY OF THE DRAWINGS

FIG. 1 is a view in elevation of a foam dispensing gun in accordance with the present invention;

FIG. 2 is a view in horizontal section taken in the plane of the line 2-2 of FIG. 1;

FIG. 3 is a detailed partial view in vertical section taken in the plane of the line 3-3 in FIG. 2 showing the valve members in an open position;

FIG. 4 is a detailed cross sectional view of the spray tip detachably fixed to the nozzle of FIG. 2 and a mixing screen interposed between the nozzle outlet and spray tip;

FIG. 5 is a perspective view of two planar mixing screens;

FIGS. 6 and 7 are perspective view of nonplanar mixing screens;

FIG. 8 is a detailed cross sectional view of an alternative embodiment of a foam dispensing gun including more than one mixing screen disposed in the mixing flow path;

FIG. 9 is a view in elevation of another alternative embodiment of a multi-component fluid dispensing device incorporating the present invention;

FIG. 10 is a view in horizontal section taken along longitudinal plane of the device of FIG. 1; and

FIG. 11 is a detailed sectional view along line 11-11 of FIG. 10.

### DETAILED DESCRIPTION OF THE PREFERRED EMBODIMENTS

The multi-component fluid dispensing device disclosed herein is substantially identical to the foam dispensing gun disclosed in U.S. Pat. No. 5,462,204 with the exception that, as described below, a mixing screen is disposed in the flow path of the foam components to enhance mixing of the foam components. U.S. Pat. No. 5,462,204 is assigned to the assignee of the present invention, and is fully incorporated herein by reference.

References to foam and foam components, herein, encompass any multi-component fluid and the fluid components comprising the multi-component fluid, such as an epoxy comprising a resin and hardener, a silicone comprising a catalyst and resin, and the like. Moreover, the present invention can be used with any thermosetting reactants, such as poly urea, phenolic, and the like without departing from the scope of the invention. In addition, although the foam dispensing gun disclosed herein is preferred, any multi-component fluid dispensing device having a nozzle through which a multi-component fluid is dispensed can be used without departing from the scope of the invention.

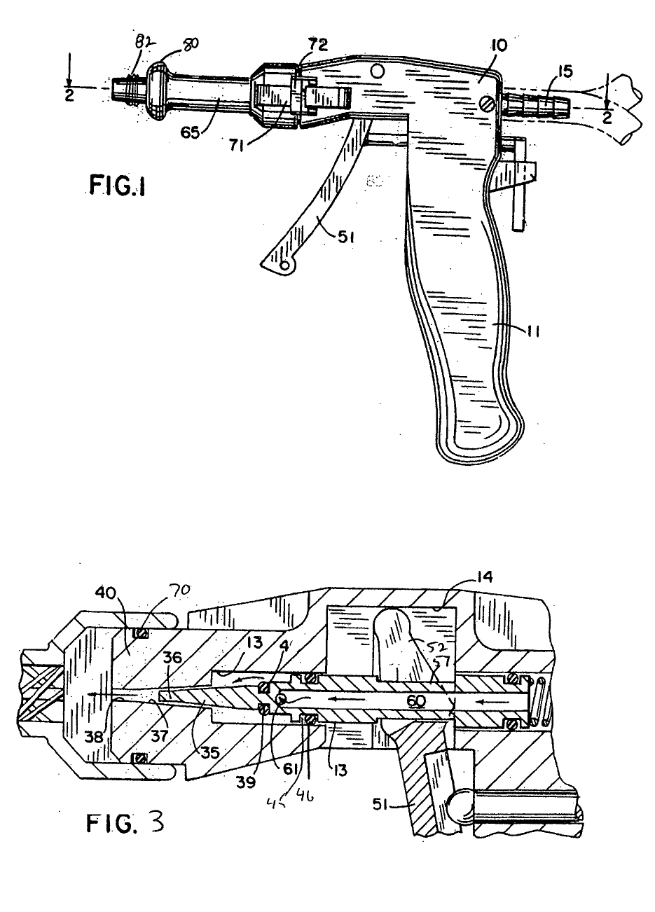

Referring to FIGS. 1-3, in general, the foam dispensing gun includes a body 10 with a handle 11 that may be formed integral with the body 10. The body 10 and handle 11 may be molded from a synthetic resin material. The body 10 is formed with a pair of longitudinal, parallel passageways 12 and 13. The passageways 12 and 13 are divided into forward and rearward portions by an intermediate chamber 14, and are in fluid communication with fluid components that form the foam. In particular, the rearward portions of the passageways 12 and 13 mount brass connectors 15 that have a ribbed end for attachment to hoses connected to pressurized containers for fluid components that are used to form the foam. Although pressurized containers for fluid components are preferred for attachment to the passageways, the fluid components can be housed in a dispensing device, such as a multi-barreled syringe and the like, that is completely self-contained, without departing from the scope of the invention.

The connectors 15 are hollow and define passageway inlets leading from the tanks of components. The bushings 22 are also hollow and mount duck-bill valves 25 in their center. The duck-bill valves 25 are formed of a rubber or other elastomeric material and function as one-way valves to permit fluid under pressure to enter a passageway 12 or 13.

Each bushing 22 is disposed against a bellville spring 26 which bears against an end of the respective connector 15 thereby urging the bushing 22 inwardly in the passageway 12 or 13 until it abuts against a shoulder 27. A coiled spring 30 is disposed in each of the passageways 12 and 13. The spring 30 bears at one end against an end of a respective bushing 22. The other ends of the springs 30 bear against the ends of brass needle valve members 31 also disposed in the passageways 12 and 13.

The needle valve members 31 span the chamber 14 and are received in both the forward and rearward portions of the passageways 12 and 13. The needle valve members 31 have a rear portion provided with a radial recess 32 that mounts an O-ring 33 to seal with the rearward portion of the passageway 12 or 13. The forward portion of each valve member 31 is formed as a conical needle valve 35 portion terminating in a circular cylindrical tip 36. The conical needle valve portion 35 and tip 36 mate with a conical valve seat 37 having a circular cylindrical extension 38 and formed in the body 10 at the front terminus of the passageways 12 and 13.

The valve seats 37 define passageway outlets, and open directly through the front face of a nose 40 on the body 10. The valve members 31 have an annular recess 39 behind the conical needle valve portion 35. The recess 39 mounts an O-ring 41 that seals the junction of the needle valve portion 35 and the conical valve seat 37 when the valve is closed, as shown in FIG. 4. The valve members 31 have an additional annular recess 45 that mounts an O-ring 46 that seals with the forward portions of the passageways 12 and 13.

The chamber 14 mounts a yoke 50 formed at the top of a trigger lever 51. The yoke 50 has a pair of arms 52 terminating in lateral bosses 53 that are received for pivotal movement in holes 54 in the two sides of the body 10, as shown in FIG. 3. The yoke 50 also includes a central rib 55 which, with the arms 52, defines two spaced cradles 56 that receive necked down portions 57 intermediate the ends of the valve members 31. The springs 30 normally urge the valve members 31 forwardly to close the needle valves 35 against the valve seats 37. The trigger lever 51 can be rotated to withdraw the valve members 31 against the urgings of the springs 30 to open the valves.

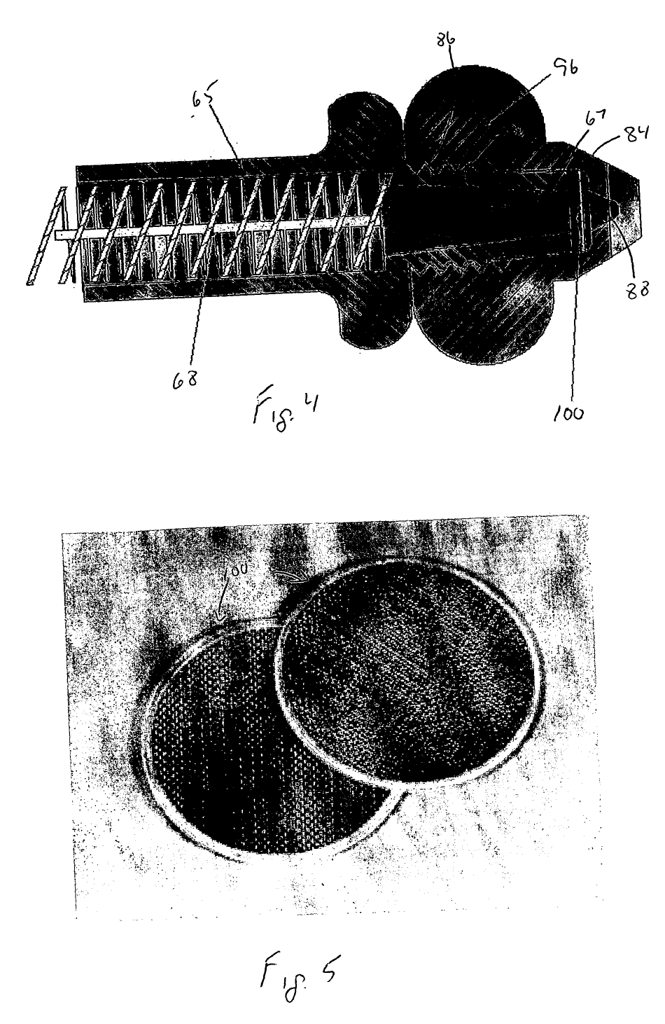

Each valve member 31 has a central internal passage 60 that terminates in a transverse port 61 that extends to the surface of the valve member at a point between the O-rings 40 and 46. As shown in FIG. 5, when the trigger lever 51 is squeezed to open the valves, fluid from the pressurized containers can pass through the central passages 60 in the valve members 31, out the ports 61, through the valve seats 37, and out of the front nose 40 of the body 10. The O-rings 46 prevent fluid from moving rearwardly along the passageways 12 or 13. As the valves are closed, the conical needle valve portions will extrude materials forwardly out of the valve seats. The seating of the needle valve in the valve seat combined with the O-rings 40 will seal off the interior of the passageways and prevent air from reaching the fluid resins in such passageways.

A disposable nozzle 65 is mounted on the front of the gun. The nozzle 65 has a hollow interior that defines a mixing chamber 66 and interposed between a nozzle inlet 63 and a nozzle outlet 67. A helical static mixer 68 of known construction is mounted in the mixing chamber 66. The rear end of the nozzle upstream of the mixing chamber 66 has an enlarged circular cylindrical portion 69 which surrounds the nose 40 of the body 10 and is sealed thereto by an O-ring 70. The cylindrical portion 69 also defines the open nozzle inlet 63. An annular ring 80 formed around the nozzle 65 proximal the outlet 67 provides grasping surfaces for securely grasping the nozzle 65 when attaching and detaching the nozzle 65 from the gun body 10. External threads 82 are formed on the nozzle 65 forward of the annular ring 80 for threadably engaging a detachable spray tip 84, such as shown in FIGS. 4-8.

A pair of resilient arms 71 extend along either side of the nozzle rearwardly from the enlarged cylindrical portion 69. The resilient arms 71 are adapted to engage ears 72 that extend from opposite sides of the body 10 adjacent the nose 40. The resilient arms 71 have a curved portion 73 adjacent their ends which terminates in a notch 74 that mates with an ear 72. The nozzle can be quickly attached to the body 10 by sliding the resilient arms 71 beneath the ears 72. The curved portions 73 will cam the arms 71 so that the arms will slide easily past the ears 72 until the notches 74 engages with the ears 72. The nozzles 65 can be easily removed by manually depressing the curved ends 73 of the arms 71 to release the notches 74 from the ears 72 and allow the arms 71 to slide past the ears 72. Although detachably fixing the nozzle to the body is preferred, as described above, the nozzle can form an integral and/or permanent part of the body, or be detachably fixed to the body using other methods, such as by using a threaded engagement, snap fit, friction fit, fasteners, and the like, without departing from the scope of the invention.

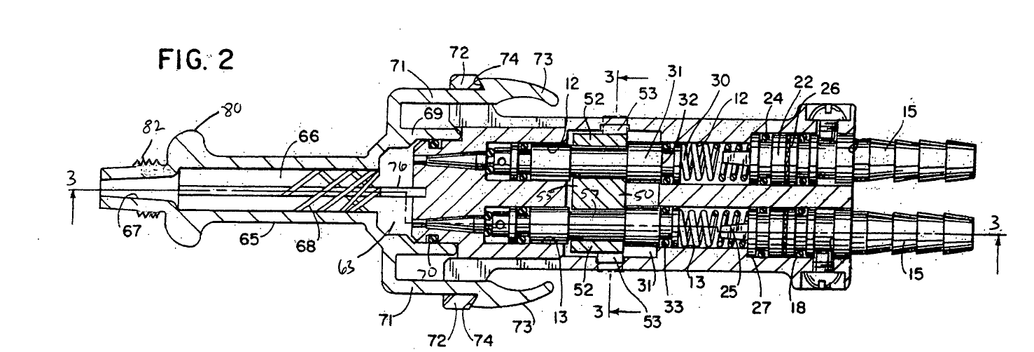

The static mixer 68 includes a wall portion 76 which is located in the open nozzle inlet 63 defined by the enlarged cylindrical end 69 of the nozzle. As shown in FIG. 2, the wall portion 76 divides the nozzle inlet 63 and is positioned between the valve seats 37 so that complete mixing of the two fluid components does not occur immediately at the nose 40. If the nozzle 65 should become clogged with foam and not be replaced, the subsequent opening of the valves could result in the fluid of higher pressure being forced from the mixing chamber through the valve seat for the other component in the reverse direction. The duckbill valves 25 prevent such cross-contamination which would result in set-up of the components within the gun if allowed to occur. Although a static mixer is disclosed and preferred, any type of mixer can be used, such as a dynamic mixer, or the mixer can be eliminated, without departing from the scope of the invention.

Referring now to FIGS. 4-8, the nozzle outlet 67 exhausts into the detachable spray tip 84 fixed to the nozzle 65. The spray tip 84 includes a hollow interior having a spray tip inlet 86 in fluid communication with a spray tip outlet 88. Preferably, the spray tip inlet 86 includes internal threads 90 that threadably engage the external threads 82 formed on the nozzle 65 to detachably fix the spray tip 84 to the nozzle 65. Although threadably engaging the spray tip with the nozzle is preferred, other means for detachably fixing the spray tip to the nozzle outlet end, such as a twist lock engagement, friction fit, snap fit, and the like, can be used without departing from the scope of the invention. Moreover, fasteners, such as set screws, hose clamps, bands, and the like, can be used to more securely fix the spray tip to the nozzle outlet end.

Opposing wings 96 extending radially from the spray tip 84 provide engagement surfaces for rotating the spray tip 84 to threadably engage the internal threads 90 with the external threads 82. Of course, other means can be provided for securely grasping the spray tip to detachably fix the spray tip to the nozzle end, such as a single wing, a knurled exterior surface, a geometric external cross section for engaging a wrench, and the like, without departing from the scope of the invention.

The foam components flow from the passageway outlets along a mixing flow path through the nozzle 65, out of the nozzle outlet 67, and through the spray tip 84. A mixing screen 100 disposed in the mixing flow path, and positioned such that foam components pass through the mixing screen 100, enhances the mixing of the foam components. Preferably, the mixing screen 100 is a wire mesh screen which is commercially available in many different mesh sizes and materials. Although a wire mesh screen is preferred, the mixing screen can be a perforated plate, molded plastic, stamped plate, and the like without departing from the scope of the invention.

In one embodiment shown in FIG. 4, the mixing screen 100 is interposed between the nozzle outlet 67 and the spray tip 84. Advantageously, with the mixing screen 100 interposed between the spray tip 84 and nozzle outlet 67, the mixing screen 100 is easily replaced if it becomes clogged or must be changed to a different mesh size to accommodate the spraying conditions or physical characteristics of the foam components. Preferably, the mixing screen 100 has a mesh size ranging between approximately 100×100 and 200×200 with a wire diameter ranging between approximately 0.003 inches and 0.010 inches to provide an open area of approximately 30%. The open area for a particular application depends, at least in part, on the viscosity of the components being mixed. Most preferably, however, the open area is between about 10% to 50%. A plurality of mixing screens 100 having the same or different mesh sizes and wire or thread diameters can be supplied with the foam dispensing gun in a kit to provide the user with replacement mixing screens at the point of foam application.

The mixing screen 100 defines a shear profile that provides shear in the foam components as they pass through the mixing screen 100 to enhances mixing without the need to increase the length of the flow path. The shear created by the shear profile increases mechanical stress in the foam components as they flow along the flow path. Advantageously, the increased mechanical stress enhances mixing in high viscosity foams components that do not traditionally mix well, as well as, lower viscosity foam components.

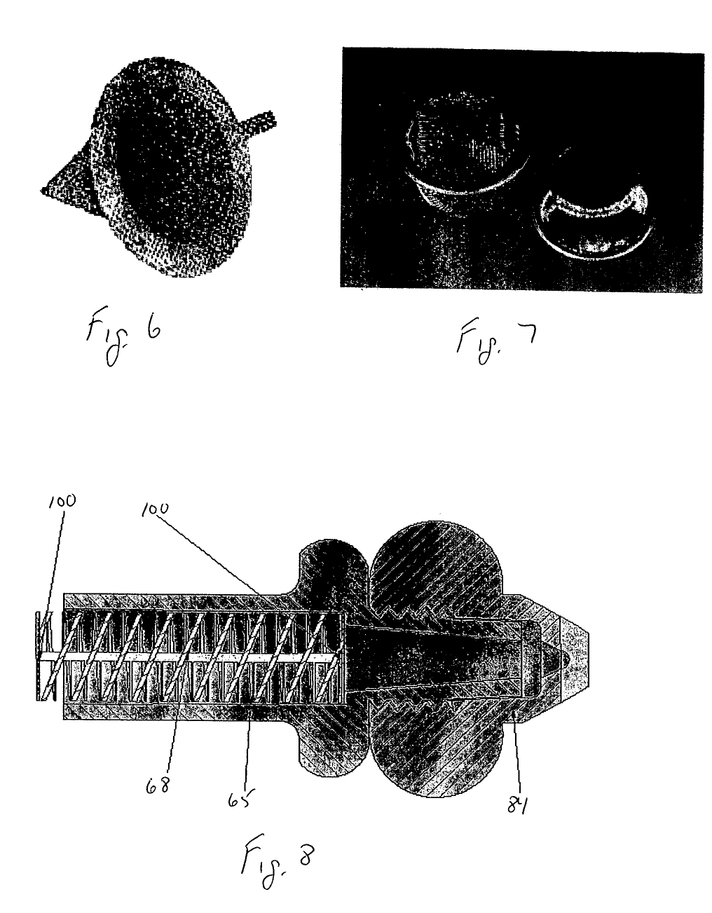

Planar mixing screens, such as shown in FIG. 5, are preferred to minimize the space necessary to accommodate the screen in the mixing flow path. However, in applications in which back pressure against the flow of the foam components caused by the planar mixing screen is a concern, mixing screens, such as shown in FIGS. 6 and 7, having nonplanar shapes, such as cones, dishes, and the like, can be used without departing from the scope of the invention. Moreover, different combinations of mixing screens having the same or different mesh sizes can be use to provide the desired shear profile for a particular application.

In certain applications, if a single mixing screen 100 does not provide sufficient enhanced mixing, a plurality of mixing screens 100 disposed in the flow path can be provided, such as shown in FIG. 8. In FIG. 8, the mixing screens 100 are positioned at the beginning and end of the static mixer 68, however, any number of mixing screens can be provided at any point in the flow path of the mixing foam components without departing from the scope of the invention. The number of mixing screens and their mesh sizes are dependent upon the foam viscosity, desired degree of mixing, and acceptable level of back pressure. Advantageously, mixing screens can be easily incorporated into any multi-component dispensing gun with minimal effort.

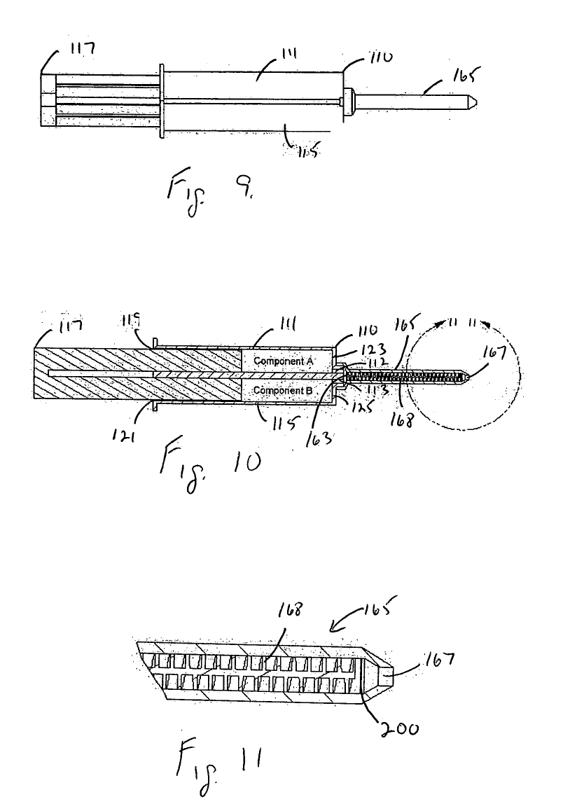

In another embodiment incorporating the present invention shown in FIGS. 9-11, a multi-component fluid dispensing device includes a body 110 having a pair of barrels 111, 115. Each barrel 111, 115 is a source of fluid component, and holds a fluid component that when mixed forms a settable multi-component fluid. A plunger 117 received in an open end 119, 121 of each barrel 111, 115 is urged to the opposing, closed end 123, 125 of each barrel 111, 115 to force the fluid components out of an opening 112, 113 formed in the closed end 123, 125 of each barrel 111, 115.

The openings 112, 113 formed in the closed end 123, 125 of each barrel 111, 115 define a fluid passageway in fluid communication with a mixing nozzle 165. Each passageway fluidly connects the respective barrel 111, 115, and thus the fluid components disposed in the barrel 111, 115, to the mixing nozzle 165, and can be as short as an aperture formed through the barrel wall, or as long as necessary to fluidly connect the source of fluid component to the mixing nozzle 165.

The mixing nozzle 165 includes a nozzle inlet 163 and a nozzle outlet 167, and the fluid components are mixed along a mixing flow path defined between the nozzle inlet 163 and nozzle outlet 167. The mixing nozzle 165 can be formed as an integral part of the body 110 or be detachable from the body 110 without departing from the scope of the invention.

A static mixer 168 disposed in the mixing flow path between the nozzle inlet 163 and nozzle outlet 167 mixes the fluid components to form the multi-component fluid. Although a static mixer 168 is disclosed and preferred, the fluid components will mix in the mixing nozzle 165 without the static mixer 168. Accordingly, the static mixer 168 can be eliminated, or replaced with a different type of mixer, without departing from the scope of the invention.

A mixing screen 200, such as described above, is disposed in the flow path to further enhance mixing the fluid components. In the embodiment shown in FIGS. 9-11, a single mixing screen 200 disposed downstream of the static mixer 168 and upstream of the nozzle outlet 167 is disclosed. However, any number of mixing screens can be provided anywhere along a flow path defined between the fluid passageways and nozzle outlet without departing from the scope of the invention.

A syringe-type multi-component fluid dispenser, as described above with reference to FIGS. 9-11, is commonly used for dispensing an epoxy comprising a resin as one fluid component and a hardener as a second fluid component. However, as in the other multi-component fluid dispensing devices disclosed above, any multi-component fluid, such as a multi-component foam, silicone, and the like, can be mixed and dispensed using a device embodying the present invention without departing from the scope of the invention.

While there has been shown and described what is at present considered the preferred embodiment of the invention, it will be obvious to those skilled in the art that various changes and modifications can be made therein without departing from the scope of the invention defined by the appended claims.

1. A multi-component fluid dispensing device, comprising:
a body having at least two passageways, each of said passageways including an inlet and an outlet, each of said inlets being in fluid communication with a fluid component;
a nozzle connected to the body and in fluid communication with said passageway outlets, wherein at least two of said fluid components enter and flow along a mixing flow path extending from said passageway outlets and through said nozzle; and
at least one mixing screen disposed in said mixing flow path to enhance mixing of said at least two fluid components.

2. The fluid dispensing device as in claim 1, in which said nozzle includes a nozzle inlet in fluid communication with a nozzle outlet, said nozzle inlet being in fluid communication with said passageway outlets, wherein said at least two of said fluid components mix as said at least two fluid components flow along said mixing flow path extending from said passageway outlets, through said nozzle between said nozzle inlet and nozzle outlet, and out of said nozzle outlet.

3. The fluid dispensing device as in claim 2, in which said nozzle includes a nozzle outlet, and a spray tip is in fluid communication with said nozzle outlet, and said at least one mixing screen is interposed between said spray tip and said nozzle outlet.

4. The fluid dispensing device as in claim 1, in which said mixing screen is formed from a wire mesh screen.

5. The fluid dispensing device as in claim 1, in which said mixing screen is selected from a group consisting of planar mixing screens and non-planar mixing screens.

6. The fluid dispensing device as in claim 1, in which said mixing screen has an open area of between about 10% to 50%.

7. The fluid dispensing device as in claim 1, in which said at least two fluid components are foam components.

8. The fluid dispensing device as in claim 1, in which said passageway inlets are in fluid communication with a pressurized fluid component.

9. A multi-component fluid dispensing kit comprising:
a multi-component fluid dispensing device defining a mixing flow path for mixing at least two fluid components;
at least one mixing screen for being disposed in said mixing flow path to enhance mixing of said at least two fluid components.

10. The fluid dispensing kit as in claim 9, in which said dispensing device includes a nozzle having a nozzle outlet, wherein said nozzle defines at least a portion of said mixing flow path, and said mixing flow path includes passing through said nozzle outlet.

11. The fluid dispensing kit as in claim 10, including a spray tip in fluid communication with said nozzle outlet, and said at least one mixing screen is interposed between said spray tip and said nozzle outlet.

12. The fluid dispensing kit as in claim 9, in which said mixing screen is formed from a wire mesh screen.

13. The fluid dispensing kit as in claim 9, in which said mixing screen is selected from a group consisting of planar screens and non-planar screens.

14. The fluid dispensing kit as in claim 9, in which said mixing screen has an open area of between about 10% to 50%.

15. The fluid dispensing kit as in claim 9, in which said at least two fluid components are selected from a group consisting of foam components, epoxy components, silicone components, and thermosetting reactants.

16. The fluid dispensing kit as in claim 9, in which said fluid dispensing device is a foam dispensing gun.

17. The fluid dispensing kit as in claim 9, in which said fluid components are pressurized.

18. A fluid dispensing device for mixing at least two fluid components to form a multi-component fluid, said mixing nozzle comprising:
a mixing nozzle defining a mixing flow path from a nozzle inlet and through a nozzle outlet, wherein the at least two fluid components mix as they pass through said mixing nozzle along said mixing flow path between said nozzle inlet and through said nozzle outlet; and
at least one mixing screen disposed in said flow path to enhance mixing of said at least two fluid components.

19. The fluid dispensing device as in claim 18, in which a spray tip is in fluid communication with said nozzle outlet, and said at least one mixing screen is interposed between said spray tip and said nozzle outlet.

20. The fluid dispensing device as in claim 18, in which said mixing screen is formed from a wire mesh screen.

21. The fluid dispensing device as in claim 18, in which said mixing screen is selected from a group consisting of planar mixing screens and non-planar mixing screens.

22. The fluid dispensing device as in claim 18, in which said mixing screen has an open area of between about 10% to 50%.

23. The fluid dispensing device as in claim 18, in which the at least two fluid components are selected from a group consisting of foam components, epoxy components, silicone components, and thermosetting reactants.

24. The fluid dispensing device as in claim 18, in which said mixing nozzle is connected to a body defining at least two passageways, each of said passageways being in fluid communication with a fluid component source.
